(19) United States
(12) Patent Application Publication
(10) Pub. No.: US 2023/0313914 A1
(43) Pub. Date: Oct. 5, 2023

(54) FIREFIGHTING ACCESSORY AND METHOD THEREFOR

(71) Applicant: Manderson Engineering Innovations Pty Ltd, Sydney (AU)

(72) Inventor: James Manderson, Lyons (AU)

(21) Appl. No.: 18/205,075

(22) Filed: Jun. 2, 2023

Related U.S. Application Data
(63) Continuation of application No. PCT/AU2020/051319, filed on Dec. 3, 2020.

(51) Int. Cl. F16L 5/02; A62C 3/10

(52) U.S. Cl. CPC F16L 5/027; A62C 3/10

(57) ABSTRACT

A firefighting accessory is provided for use in fighting a fire through an aperture in a bulkhead. The firefighting accessory includes a securing arrangement and a connector. The securing arrangement is for securing the firefighting accessory through the aperture in the bulkhead. The connector is for connecting a source of fire extinguishing agent. The firefighting accessory is configured for guiding a flow of firefighting agent through the aperture to fight the fire in operation. The securing arrangement preferably includes a barb arrangement with expandable barbs that can move between a retracted position and a deployed position. While the barbs are in their retracted position, the firefighting accessory can be inserted through the aperture in the bulkhead. A tensioning arrangement then secures the barbs against an inner surface of the compartment that the fire is in.

### CROSS REFERENCE TO RELATED APPLICATIONS

This application is a continuation under 35 U.S.C. § 120 of International Application PCT/AU2020/051319, filed Dec. 3, 2020, the contents of which are incorporated by reference herein.

### FIELD OF THE INVENTION

The present invention relates to a firefighting accessory and in particular to a firefighting accessory for use in firefighting on vessels that define compartmented spaces.

The invention has been developed primarily for use in/with seagoing vessels and will be described hereinafter with reference to this application. However, it will be appreciated that the invention is not limited to this particular field of use, and could be used in other environments such as on aircraft, submarine, ground vehicles, and in buildings with enclosed spaces.

### BACKGROUND

At present, if a fire breaks out in a particular compartment on a vessel at sea, then extinguishing the fire can be extremely hazardous, as access to the fire may be limited, and because heat can build up in enclosed spaces very quickly. Opening up of hatches to the compartment in which the fire is present may be hazardous, as this could feed oxygen to the fire, causing an escalation of the fire.

At present, one of the methodologies used to fight fires within a compartment on a vessel includes cutting through the bulkhead from an adjacent area, such as a passageway or adjacent room. Cutting of the bulkhead may be carried out by oxyacetylene gas torch, or using some other exothermic cutting process, to cut a hole in the typically steel bulkhead. Firefighters then try and spray firefighting chemicals or water through the aperture in the bulkhead. However, making an aperture in the bulkhead using an oxyacetylene torch or exothermic process may present its own risks. The oxyacetylene torch may cause the ignition of the highly volatile gases smoke layer that accumulates above the fire within the compartment. Further, the use of oxyacetylene torches may cause additional items to be set alight within the fire zone. Further, a stream of water that is configured to fit through a small aperture may not be efficient in dousing the fire. Further, personnel are required to hold the firefighting hose at the correct angle and height to enable water or other firefighting agents to be sprayed into the area in which the fire is present, which may tire the personnel and exhaust firefighting resources.

The present invention seeks to provide a firefighting accessory, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

According to a further aspect, the present invention may be said to consist in a firefighting accessory for use in fighting a fire through an aperture in a bulkhead, the firefighting accessory comprising:
a. a securing arrangement adapted for securing the firefighting accessory at or towards the aperture in the bulkhead; and
b. a connector configured for connection to a source of fire extinguishing agent;
c. wherein the firefighting accessory is configured for guiding a flow of firefighting agent through the aperture to fight the fire in operation.

In one embodiment, the securing arrangement includes an expanding arrangement.

In one embodiment, the expanding arrangement comprises a reconfigurable expanding arrangement that is reconfigurable between:
a. a retracted configuration in which the expanding arrangement is insertable through an aperture in a bulkhead in operation; and
b. a deployed configuration in which the expanding arrangement is not retractable through the aperture in the bulkhead.

In one embodiment, the expanding arrangement is a barb arrangement.

In one embodiment, the expanding arrangement comprises a conduit body including a conduit for guiding a flow of firefighting agent in use, the conduit extending between an inlet at a rear end and an outlet at a fore end.

In one embodiment, the connector is configured for connection to one or more selected from a firefighting hose, and a pressurised vessel of fire extinguishing agent.

In one embodiment the securing arrangement includes a conduit body.

In one embodiment, the connector is configured for connection to a firefighting hose.

In one embodiment, the connector is configured for connection to a fire extinguisher or pressurised vessel containing fire extinguishing agent.

In one embodiment, the firefighting accessory includes a support arrangement for supporting a fire extinguisher.

In one embodiment, the firefighting accessory includes a fire extinguisher.

In one embodiment, the firefighting accessory includes an extinguisher conduit for connecting the fire extinguisher to the rear of the conduit body.

In one embodiment, the extinguisher conduit is composed of flexible pipe.

In one embodiment, the support arrangement is configured for being supported by the conduit body.

In one embodiment, the connector is associated with the rear end of the conduit body.

In one embodiment, the barb arrangement includes a barb body and at least one or more barb members.

In one embodiment, the barb body includes an aperture configured for receiving the conduit body.

In one embodiment, the aperture through the barb body is threaded.

In one embodiment, the threaded aperture through the barb body is configured for engagement with complementary thread on the upper surface of the conduit body.

In one embodiment, the firefighting accessory includes a spray nozzle.

In one embodiment, the spray nozzle is associated with the fore end of the conduit.

In one embodiment, the spray nozzle is located at the outlet of the conduit body.

In one embodiment, the spray nozzle is configured for generating a dousing mist from the flow of firefighting agent.

In one embodiment, the firefighting accessory includes a hose.

In one embodiment, the hose is attached or attachable to the inlet of the conduit.

In one embodiment, the barb arrangement includes a plurality of barb members.

In one embodiment, at least one or more of the plurality of barb members are pivotable relative to the conduit body.

In one embodiment, the at least one or more of the plurality of barb members are pivotable about a pivot pin.

In one embodiment, at least one or more of the plurality of barb members are biased.

In one embodiment, at least one or more of the plurality of barb members are biased to their deployed configuration.

In one embodiment, the firefighting accessory includes a biasing arrangement for biasing at least one or more of the plurality of barb members to their deployed configuration.

In one embodiment, the biasing arrangement includes at least one elastic member.

In one embodiment, the elastic member extends within a channel on at least one or more barb members.

In one embodiment, the elastic member extends within a channel on each of the barb members.

In one embodiment, the channel is located on an outer surface of a barb member and towards a fore end of the barb member.

In one embodiment, at least one or more barb members are receivable within channels in the conduit body when they are in their retracted configuration.

In one embodiment, at least one or more of the plurality of barb members spring loaded to move to their deployed configuration.

In one embodiment, one or more selected from the spray nozzle, the barb members and the conduit are composed of fire resistant material.

In one embodiment, the firefighting accessory includes a closure configured for closing the aperture in the bulkhead.

In one embodiment, the firefighting accessory includes a tensioning arrangement for tensioning the conduit body between the closure and the at least one or more barb members.

In one embodiment, the tensioning arrangement includes a threaded nut engageable with a complementary thread on the conduit body.

In an alternative embodiment, the tensioning arrangement includes a threaded nut engageable with a complementary thread on the barb body.

In one embodiment, the threaded nut is a wingnut.

In one embodiment, the conduit body is a cylindrical body.

A method of fighting a fire in a compartment through an aperture in a bulkhead, the method comprising the steps of:
a. providing a firefighting accessory as described;
b. securing the firefighting accessory at or towards the aperture;
c. connecting a source of extinguishing agent to the firefighting accessory; and
d. directing fire extinguishing agent at the fire via the aperture in the bulkhead.

In one embodiment, the step of directing fire extinguishing agent via the aperture includes the step of:
a. guiding a flow of fire extinguishing agent through a conduit in a conduit body.

In one embodiment, the step of guiding a flow of fire extinguishing agent through a conduit in a conduit body includes the step of:
a. inserting a fore end of the conduit body through an aperture in the bulkhead from the non-fire side of bulkhead.

In one embodiment, the method includes the step of:
a. engaging barb members with the bulkhead on the fire side of the bulkhead to prevent retraction of the firefighting accessory from the aperture.

In one embodiment, the method includes the step of:
a. engaging a tensioning arrangement with a rear end of the firefighting accessory to abut the barb members against the fire side of the bulkhead.

In one embodiment, the step of attaching a source of extinguishing agent to the inlet of the firefighting accessory includes the step of:
a. coupling one or more selected from a firehose and a fire extinguisher to a connector at the rear end of the conduit body.

In one embodiment, the method includes the step of:
a. moving the barb members to a retracted configuration before inserting the fore end of the firefighting accessory through the aperture.

In one embodiment, the method includes the step of:
a. causing the barb members to move from their retracted configuration to a deployed configuration before engaging the barb members with the bulkhead.

Any reference in this specification to the term “bulkhead” shall be construed to include a bulkhead, deckhead, floor, wall, lining, or compartment enclosure that may lie between a fire and firefighters.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWING

Notwithstanding any other forms which may fall within the scope of the present invention, a preferred embodiment of the invention will now be described, by way of example only, with reference to the accompanying drawings in which:

FIG. 1 shows a top front perspective view of a first embodiment of a firefighting accessory;

FIG. 2 shows a right side view of the firefighting accessory of FIG. 1;

FIG. 3 shows a bottom right perspective view of the firefighting accessory of FIG. 1;

FIG. 4 shows a top right perspective view of the firefighting accessory of FIG. 1.

FIG. 5 shows a partial close-up view of the firefighting accessory of FIG. 3;

FIG. 6 shows a top right perspective cutaway view of the firefighting accessory of FIG. 1 inserted through an aperture in a bulkhead;

FIG. 7 shows a close-up view of FIG. 6;

FIG. 8 shows a front view of FIG. 6;

FIG. 9 shows a close-up view of FIG. 8;

FIG. 10 shows a cutaway cross-sectional view of FIG. 9

FIG. 11 shows a front elevation view of a second embodiment of a firefighting accessory;

FIG. 12 shows a top front right perspective view of the firefighting accessory of FIG. 11;

FIG. 13 shows a right elevation view of the firefighting accessory of FIG. 11;

FIG. 14 shows a bottom front perspective view of the firefighting accessory of FIG. 11;

FIG. 15 shows a side elevation view of the firefighting accessory of FIG. 11 including a support arrangement for a fire extinguisher, the firefighting accessory being inserted through a bulkhead and supporting a fire extinguisher;

FIG. 16 shows a side elevation view and close-up view of the firefighting accessory of FIG. 11 inserted through a container roof;

FIG. 17 shows a cutaway bottom perspective view of FIG. 16;

FIG. 18 shows a top left perspective view of FIG. 16; and

FIG. 19 shows a bottom view of the firefighting accessory of FIG. 11 inserted through a container wall.

### DETAILED DESCRIPTION OF THE PREFERRED EMBODIMENTS

It should be noted in the following description that like or the same reference numerals in different embodiments denote the same or similar features.

A firefighting accessory according to a first aspect of the invention is generally indicated by the numeral 1000.

The firefighting accessory includes a securing arrangement, device or mechanism for securing the firefighting accessory at or towards an aperture, and a connector for connecting the firefighting accessory to the outlet of a fire extinguishing agent dispenser, such as a firehose or a fire extinguisher.

The securing arrangement is preferably in the form of an expanding arrangement, mechanism or device that secures the firefighting accessory within the aperture, and also preferably engages with the wall on the opposed side of the aperture in order to prevent the retraction of the firefighting accessory. However, in alternative embodiments, the expanding arrangement could expand into the aperture itself and rely on friction between the firefighting accessory and the aperture to be held in place.

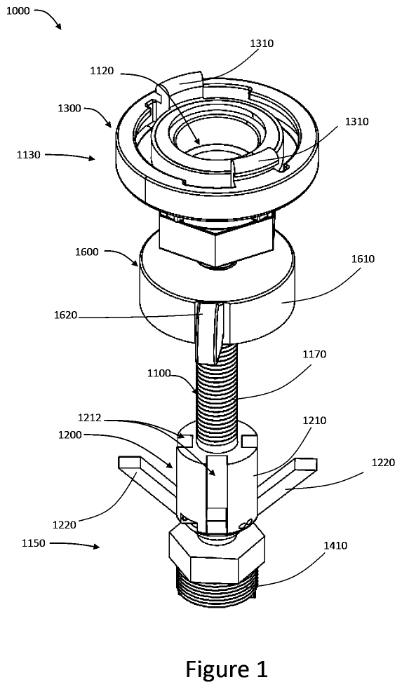

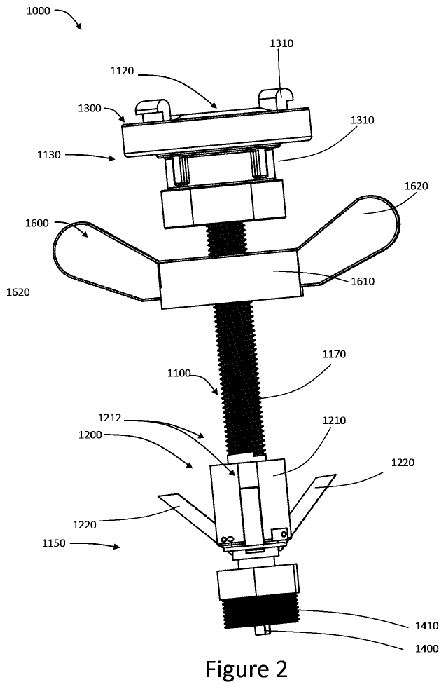

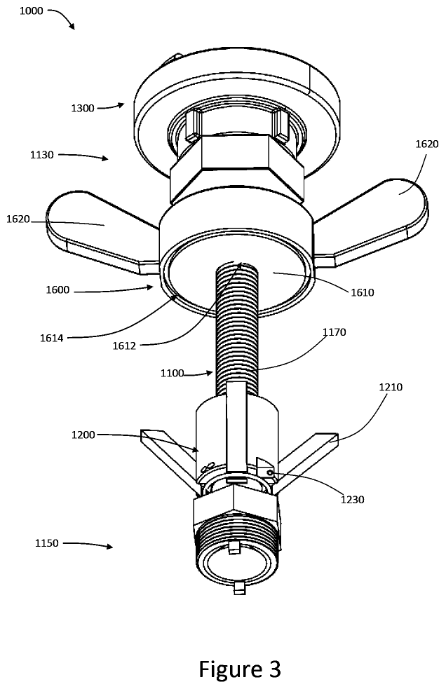

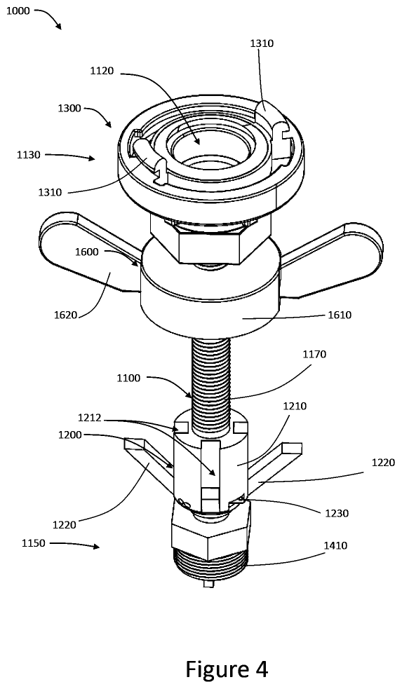

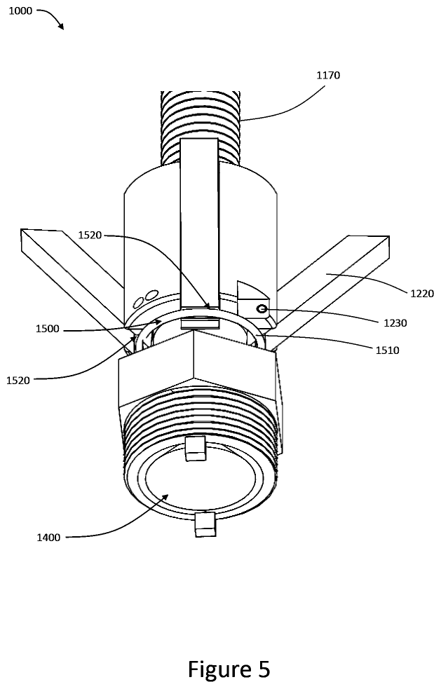

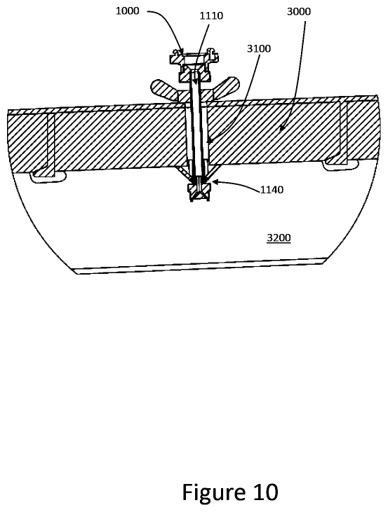

In one embodiment now described, and with reference to FIGS. 1-5, there is provided a firefighting accessory for use in fighting a fire through a preferably circular bore or aperture 3100 in a wall or bulkhead 3000 (shown in FIG. 10), for example on a seagoing vessel (not shown).

The firefighting accessory 1000 includes a securing arrangement for securing the firefighting accessory 1000 at or towards the aperture 3100, and a connector 1300 for connecting the firefighting accessory to the outlet of a fire extinguishing agent dispenser, such as a firehose or a fire extinguisher.

The securing arrangement is preferably provided in the form of a conduit body 1100 that defines a passage or conduit 1110 for guiding a flow of firefighting agent (not shown) in use, together with a reconfigurable barb arrangement 1200 and a tensioning arrangement as will be described in more detail below. These together also function as an expanding arrangement as will be described below.

The conduit 1110 preferably extends between an inlet 1120 at a rear end 1130, and an outlet 1140 at a fore end 1150. At the outlet 1140 at the fore end 1150 of the conduit body 1100, a spray nozzle 1400 is provided for converting the flow of firefighting agent into a spray or dousing mist which can be used to douse or suppress a fire on the opposite side of the bulkhead 3000. The spray nozzle 1400 preferably includes thread formations 1410 which may be connected to complementary thread formations (not shown) on the conduit body 1100. The spray nozzle 1400 is of a smaller cross section than the aperture 3100 in the bulkhead.

The firefighting accessory 1000 further includes an expanding arrangement in the form of a reconfigurable barb arrangement 1200. The barb arrangement 1200 is a reconfigurable between a retracted configuration in which the barb arrangement is insertable through an aperture 3100 in the bulkhead 3000 in operation; and a deployed configuration in which the barb arrangement 1200 is not retractable through the aperture 3100. The barb arrangement 1200 includes a barb body 1210 and a plurality of barb members 1220.

In the embodiment shown in the figures, the firefighting accessory 1000 includes 4 barb members spaced regularly around the periphery of the conduit body 1100. In alternative embodiments, it is envisaged that more less barbs could be provided. The barb members 1220 are each pivotable about a pivot pin 1230 that extends into an associated channel 1212 in the barb body 1210. The barb members 1220 are each pivotably movable around pivot pin 1230 between a deployed position in which the barb member is received into each pivot about pivot pin 1230 pivotably movable around pivot pin and a retracted position in which the barb member 1220 is received within channels 1212 in the barb body 1210. The deployed position of the barb members 1220 corresponds with the deployed configuration of the barb arrangement 1200, and the retracted position of the barb members 1220 corresponds with the retracted configuration of the barb arrangement 1200.

In an alternative embodiment (not shown) it is envisaged that the conduit body and barb body may be presented as a single member.

Each of the barb members 1220 are biased to their deployed position by a biasing arrangement 1500. The biasing arrangement 1500 includes an elastic ring member 1510 that extends around the outer periphery of the plurality of barb members, and is located within a channel 1520 located on an outer surface of each of the barb members 1220 towards a fore end of each barb member. The elastic ring member 1510 is composed of resilient material, and serves to pull the fore ends of the barb members together, causing each of the barb members 1220 to pivot around pivot pin 1230, and causing a rear end of each barb member 1220 to extend from the outer periphery of the barb body 1210. The barb body 1210 is of a smaller diameter than the aperture 3100 in the bulkhead 3000.

When the rear ends of the barb members 1220 are extended from the outer periphery of the barb body 1210, the rear ends of the barb members also extend outwardly of the outer periphery of the conduit body 1100 and/or spray nozzle 1400.

It is envisaged that a wide variety of biasing arrangements could be used to bias the barb members to their deployed position. As an example, in alternative embodiments leaf springs, helical springs or the like could be used acting in either compression or tension.

The firefighting accessory 1000 further includes a connector 1300 associated with the inlet 1120 of the conduit body 1100 at the rear end 1130. The connector 1300 is preferably engageable with threaded formations on the conduit body 1100 to connect securely and sealingly with the conduit body. In alternative embodiments, the connector may be permanently secured to the conduit body, for example by welding or brazing.

The connector 1300 is preferably configured as a commonly known connector to ship firehoses, such as a “Storz” connector similar to that described in U.S. Pat. No. 764,018, and includes connector formations 1310 that are configured for engagement with complementary connector formations on the firehose. However, it will be appreciated that a wide variety of alternative connector configurations may be possible. The firefighting connector 1000, including all of its components and connectors, is preferably adapted to safely handle firefighting liquid, agent or fluid such as foam or water at between 150 psi (1.03 MPa) and 300 psi (2.06 MPa).

Further, it is envisaged that the firefighting connector 1000, including all of its components and connectors will be preferably adapted to handle the high temperatures that may be encountered after being inserted through a bulkhead into a compartment that has a fire in it. It is expected that the firefighting connector 1000 including all of its components and connectors will preferably be composed of a heat resistant material such as metal, mineral or mineral like materials, a composite of such materials, or any other suitable material. The elastic member 1510 is preferably composed of a metal garter spring, however it may also be composed of silicone or some other suitable heat resistant resilient material, including heat resistant plastic materials, mineral materials, metal materials or any other suitable material. It will be appreciated that the elastic member need only bias the barb members to their deployed position for a short amount of time until the barb members can be securely engaged against the inner wall of the bulkhead, and the tensioning arrangement in the form of the sealing member engaged to secure the firefighting accessory in place.

It is envisaged that in an alternative embodiment (not shown) the firefighting connector 1000 can also include a built-in hose (not shown) attached to the inlet of the conduit body and adapted for connecting to another firefighting hose, or to a pressurised outlet for firefighting liquid on the vessel. In this embodiment, the connector would be located at the end of the hose.

The firefighting accessory 1000 further includes a closure 1600 that together with the conduit body 1100 is configured for restricting airflow through the aperture in the bulkhead in operation, and preferably sealing the aperture in the bulkhead, at the rear end of the conduit body 1100. The closure 1600 includes a circular disc 1610 that includes a threaded aperture 1612 through its centre. The threaded apertures 1612 are to engage with complementary thread formations 1170 on the rear end 1130 of the conduit body 1100 when it is received through the aperture 1612. The closure 1600 further includes manually manipulatable handles in the form of wingnut handles 1620 that can be manually manipulated by a person to turn the closure 1600 on the complementary threads 1170.

It is envisaged that the closure 1600 can further include an O-ring (not shown) that is located in a channel 1614 aligned with an inner face of the disk 1610, so that when the disk is turned onto the thread formations 1170 in use, the O-ring is pushed up against the bulkhead 3000.

In this way, the closure 1600 interacting together with the conduit body 1100 and the barb members 1220 in their deployed position acts as a tensioning arrangement, mechanism or device, wherein the conduit body 1100 is put into tension, thereby pulling the closure 1600 and barb members 1220 towards each other and causing them to engage firmly with the bulkhead 3000.

In alternative embodiments (not shown) it is envisaged that the sealing member 1600 can be independent of the tensioning arrangement, although this is not preferred.

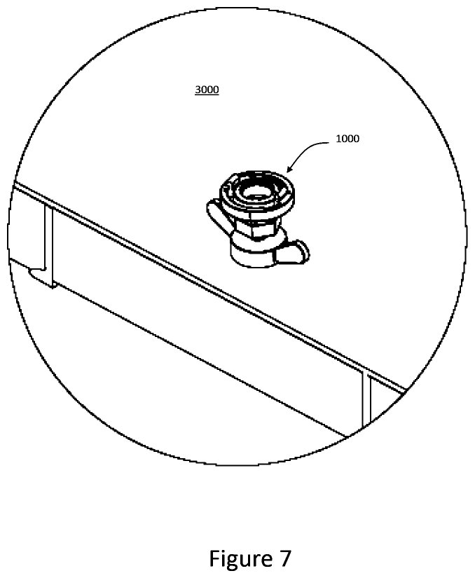

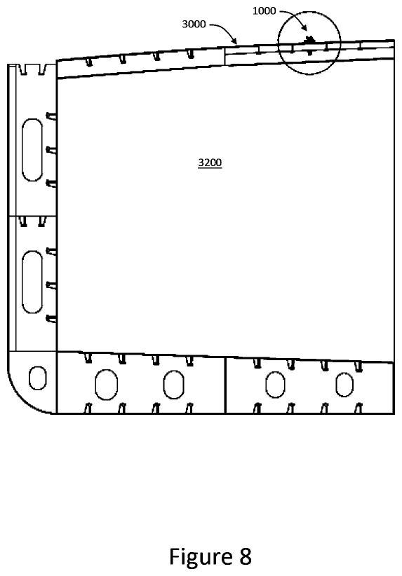

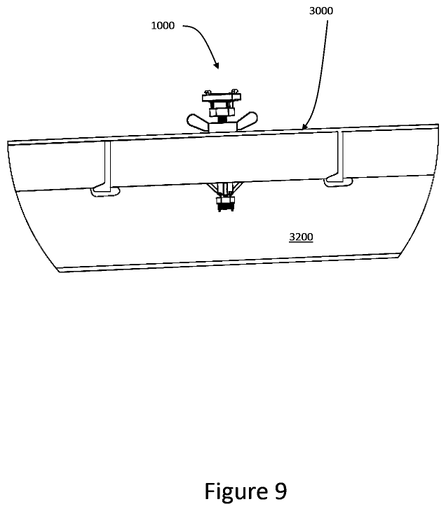

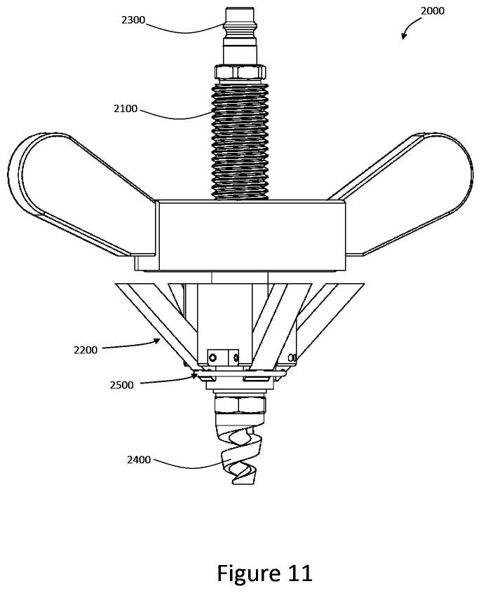

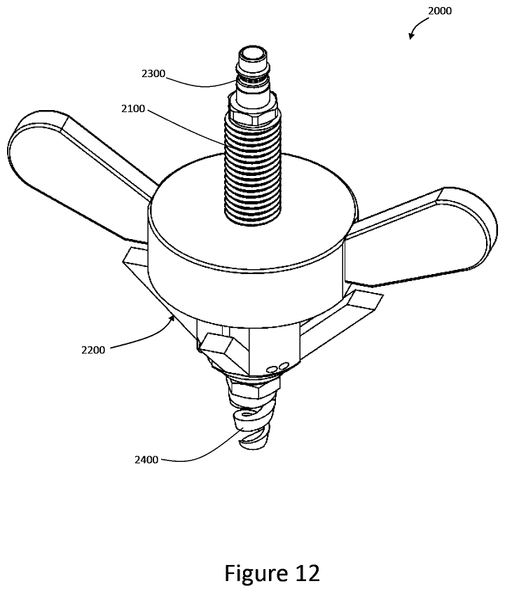

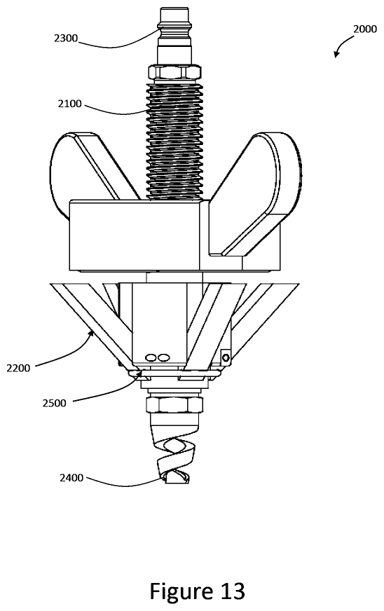

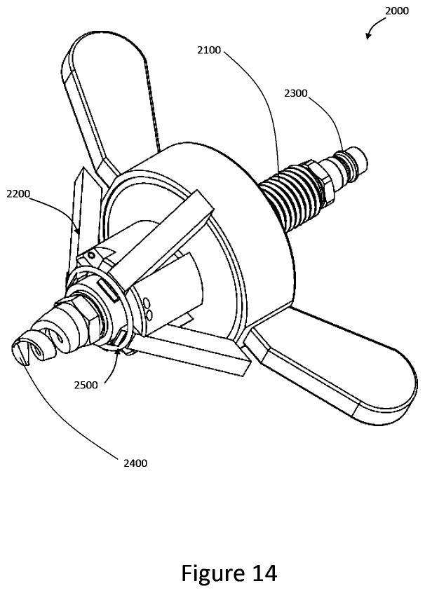

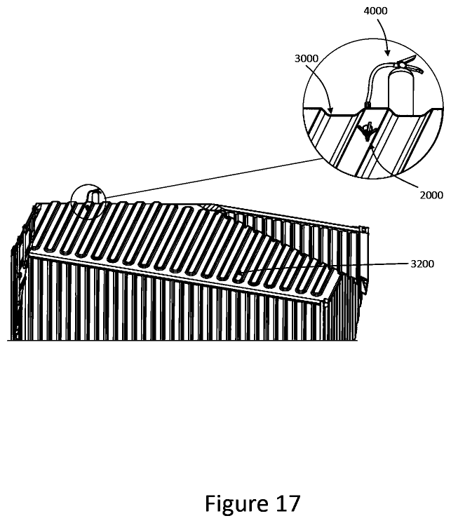

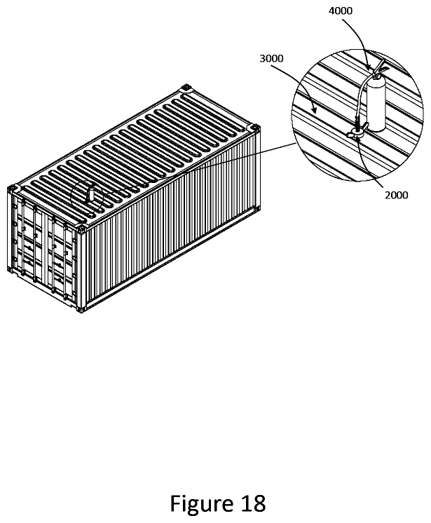

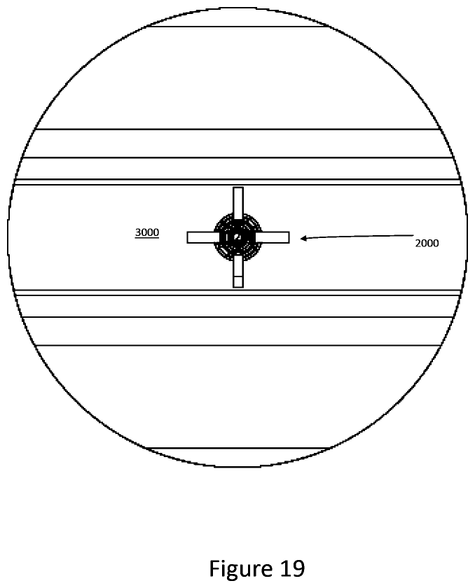

Another embodiment of a firefighting accessory 2000 is now described with reference to FIGS. 11-19. The firefighting accessory 2000 also includes a conduit body 2100 including a conduit (not shown) there through, reconfigurable barb arrangement 2200, and biasing arrangement 2500, similar to the firefighting accessory 1000 shown in FIGS. 1-10.

However, the firefighting accessory 2000 shown in FIGS. 11-19 is configured for being connected to an alternative source of fire extinguishing agent, in the form of a fire extinguisher 4000. It is envisaged that a wide variety of extinguisher types may be connectable to the firefighting accessory 2000, including water, foam, dry powder, carbon dioxide and/or wet chemical extinguishers.

The firefighting accessory 2000 includes a connector 2300 that is configured for connection to a complementary connector 4200 associated with the extinguisher 4000, preferably via a flexible pipe 4100. Further, the firefighting accessory 2000 includes a specialist nozzle 2400 connected to the front of the conduit body 2100 for receiving the fire extinguishing agent through the conduit 2110, and dispensing the fire extinguishing agent into the compartment and/or container.

In an alternative embodiment (not shown) it is envisaged that the firefighting accessory could include its own high-pressure compartment for storage of fire extinguishing agent, however this is not preferred as currently processes and systems are in place for the inspection, maintenance and refilling of ordinary fire extinguishers.

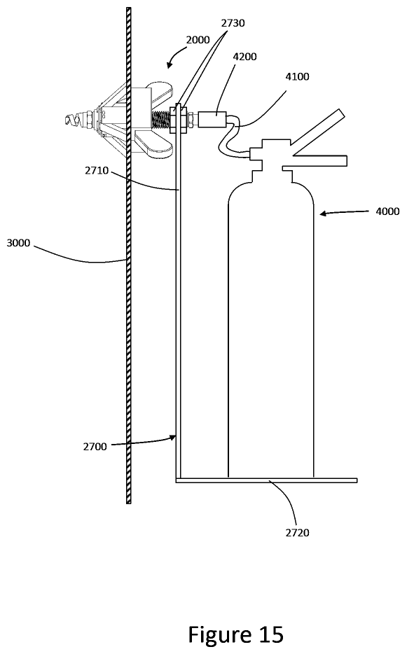

In the embodiment shown in FIG. 15, the firefighting accessory 2000 includes a support arrangement 2700 for the fire extinguisher. The support arrangement includes a vertical plate 2710 including an aperture (not shown) that is configured to be hung on the rear of the conduit body 2100, to be supported by the conduit body. In an alternative embodiment, the support arrangement could include a hook for being hung over the conduit body 2100. The supporting arrangement 2700 also includes a horizontal plate 2720 on which a fire extinguisher 4000 can be supported. The supporting arrangement 2700 can be secured on the rear of the conduit body 2100 by a pair of securing nuts 2730 that have internal threads configured for engagement with external threads on the conduit body. Such a supporting arrangement may be useful where the location of the fire within the compartment necessitates that the aperture 3100 that the conduit body 2100 is inserted into is at a high level relative to the floor, and will free up personnel from having to support the fire extinguisher 4000.

It is further envisaged that in an alternative embodiment, a larger size pressurised vessel containing extinguishing agent can be provided that may be mounted on wheels, for use where the compartment in which the fire is to be doused is of a large size (for example within a 40 foot container).

In Use

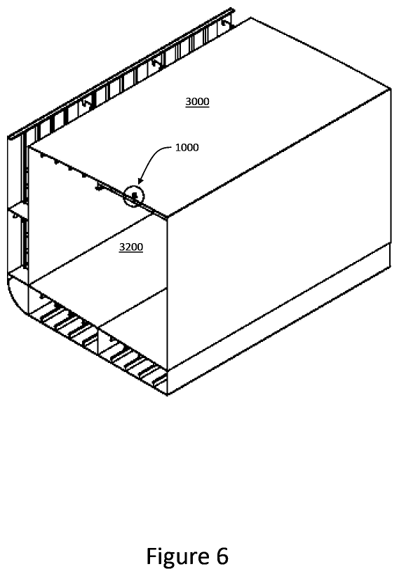

Now as shown with reference to FIGS. 6-9, the firefighting accessory 1000 will be described for use in fighting a fire in a compartment 3200 such as a storage compartment, a cabin, or a container through a wall or bulkhead 3000.

On detection of a fire in a particular compartment, the compartment would typically be sealed off. The compartment may be sealed off automatically, or by closing watertight doors in the vessel. This will serve to contain the fire to that compartment. However, the fire still needs to be put out before it can spread and cause more damage. Where the compartment cannot be sealed off, for example where the compartment is within a container, then airflow to the compartment will preferably be restricted as best as possible.

An aperture 3100 (shown in FIG. 10) will then be bored into the bulkhead from outside of the compartment where the fire is detected. The aperture will typically be circular in shape, due to the use of a circular cutting tool. The firefighting accessory 1000 will then be provided and the fore end 1150 of the conduit body will be inserted into the aperture 3100. On insertion of the fore end 1150 of the conduit body 1100 into the aperture 3100, the barb members will automatically move to their retracted position. Once the conduit body 1100 has been pushed through aperture 3100 to a sufficient degree, the barb members will move under action of the biasing arrangement 1500 to their deployed position, thereby preventing retraction of the conduit body 1100 from the bulkhead 3000.

The threaded aperture 1612 of the sealing member 1600 will then be engaged with the complementary thread formations 1170 on the conduit body 1100, and will be turned using wingnut handles 1620 until the sealing member 1600 abuts with the bulkhead 3000. Further rotation of the sealing member 1600 will cause the conduit body 1100 to be retracted from the aperture until barb members 1220 engage with an opposed face of the bulkhead, thereby causing the conduit body 1100 to be tensioned. In this state, the conduit body 1100 is held rigidly within the aperture 3100.

A firehose (not shown) can then be connected to the connector 1300, and firefighting agent pumped through the firehose and into the conduit 1110, where it agent pass through the spray nozzle 1400. The spray nozzle 1400 may cause the firefighting agent to be disbursed in a mist or similar, for purposes of suppressing the fire within the compartment.

Wherein the firefighting accessory 1000 includes its own firehose, the firehose can merely be coupled to a pressurised source of firefighting agent, and the flow turned on.

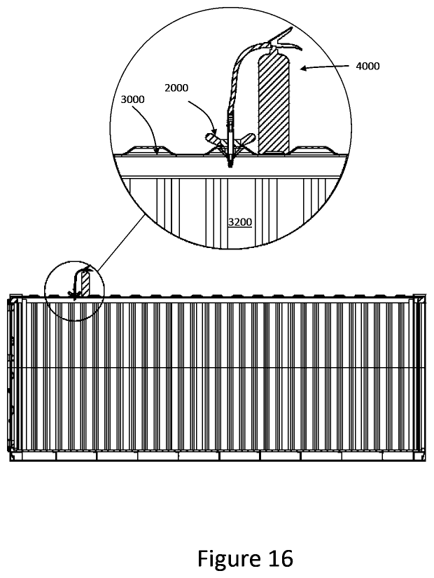

A similar method of fighting a fire in a compartment will now be described with reference to FIGS. 16-19 using firefighting accessory 2000. Similarly to the method described above, aperture will initially be generated in the bulkhead and/or container wall 3000, preferably by boring an aperture 3100 through the bulkhead or wall 3000. The firefighting accessory 2000 will be inserted into position and secured similarly to the method described above, however instead of connecting a firehose to the firefighting accessory, the complementary connector 4200 of a fire extinguisher 4000 will be connected to the connector 2300 of the firefighting accessory, preferably via a flexible pipe 4100.

Where the aperture 3100 has been bored into the bulkhead or wall 3000 at a high level, the support arrangement 2700 can be hung over the rear of the conduit body 2100 and secured in place using securing nuts 2730. The fire extinguisher 4000 can then be supported on the horizontal plate 2720 while the complementary connectors 4200 are connected to the connected 2300 of the firefighting accessory 2000. In an alternative embodiment, the supporting arrangement can be configured to be hung on the aperture itself.

It is further envisaged that the firefighting accessory 2000 could be utilised and deployed as a permanent or semi-permanent fixture for use with compartments that are either critical in nature, or that may be used for storage of higher risk materials that present an increased probability of ignition. Examples of such compartments include electrical switchboard compartments, paint storage compartments and/or on-site hazardous chemical lockers.

In another embodiment (not shown in the figures) it is envisaged that a large size pressurised storage container full of extinguishing agent may be wheeled into position alongside the installed firefighting accessory 2000, and connected to the conduit body 2100 via connector 2300.

It will be appreciated by persons skilled in the art that the provision of a firefighting accessory as described above can provide useful benefits in that the firefighting accessory can be left in place and will not need to be held by a firefighter while the firefighting agent is directed through an aperture in the bulkhead. This frees up personnel for other duties, while remaining effective.

It is further envisaged that in alternative embodiments, a barb arrangement need not necessarily be used, and any expanding arrangement that allows for the insertion of the firefighting accessory into an aperture and subsequent expansion of the firefighting accessory to remain in place within the aperture could be used. For example, an expanding inflatable arrangement could be used. Further, such an expanding arrangement need not necessarily use tension to hold the firefighting accessory in place, and instead could expand into the aperture, wedging itself in position. It will be appreciated by person skilled in the art that a wide variety of expanding arrangements may be provided that would serve to wedge the firefighting accessory within the aperture, or secure the firefighting accessory to the inside surface of the bulkhead.

Further, in an alternative embodiment it is envisaged that the conduit body need not necessarily extend all the way through the aperture in use, and instead could be held at an entrance to the aperture. However this is not preferred, especially where a misting nozzle used, as this may result in water being collected within double walls of the bulkhead.

It is envisaged that the securing arrangement need only secure the outlet of a firehose in position at or towards the aperture in order to obtain the primary advantages of the present invention, this being a reduction in the amount of personnel required. However the embodiments described above are preferred in that they offer the further important advantage of being able to restrict airflow through the aperture 3100 in the bulkhead, preventing backdraft and oxygen escalation of the fire.

In another embodiment (not shown) the securing arrangement could be in the form of a hook that hooks into the aperture and provides a connector on the non-fire side of the bulkhead for connecting to the outlet of the extinguishing agent dispenser to hold it in place, to thereby allow the unmanned distribution of extinguishing agent through the aperture, without providing a conduit for guiding the extinguishing agent through the aperture itself. It may also include a support for supporting the dispenser.

### Interpretation

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the marine, space, vehicle and firefighting industries.

What is claimed is:

1. A firefighting accessory for use in fighting a fire through an aperture in a bulkhead, the firefighting accessory comprising:
a. a securing arrangement adapted for securing the firefighting accessory at or towards the aperture in the bulkhead, the securing arrangement including:
a conduit body including a fore end and a rear end and defining a conduit for the flow of firefighting agent, the conduit body being configured for extending the fore end through the aperture, in use, the conduit body including thread formations at least partly along its length; and
an expanding arrangement movable between
a retracted configuration in which the expanding arrangement can be at least partially inserted through the aperture with the conduit body in use, and
a deployed configuration in which the expanding arrangement is not movable through the aperture in use; and
a tensioning arrangement including a closure configured for threaded engagement with the thread formations on the conduit body, the tensioning arrangement being configured for tensioning the conduit body between the expanding arrangement and the closure in use; and
b. a connector configured for connection to a source of fire extinguishing agent;
c. wherein the firefighting accessory is configured for guiding firefighting agent through the aperture to fight the fire in operation.

2. The firefighting accessory as claimed in claim 1, wherein the expanding arrangement is a barb arrangement.

3. The firefighting accessory as claimed in claim 1, wherein the connector is configured for connection to one or more selected from a firefighting hose, and a pressurised vessel of fire extinguishing agent.

4. The firefighting accessory as claimed in claim 2, wherein the barb arrangement includes a barb body and at least one or more barb members.

5. The firefighting accessory as claimed in claim 1, wherein the firefighting accessory includes a nozzle.

6. The firefighting accessory as claimed in claim 1, wherein the firefighting accessory includes a hose.

7. The firefighting accessory as claimed in claim 6, wherein the hose is attached or attachable to the inlet of the conduit.

8. The firefighting accessory as claimed in claim 4, wherein the barb members are reconfigurable between a retracted position and a deployed position.

9. The firefighting accessory as claimed in claim 4, wherein at least one or more of the barb members are pivotable relative to the conduit body.

10. The firefighting accessory as claimed in claim 4, wherein the firefighting accessory includes a biasing arrangement for biasing at least one or more of the barb members between their deployed position and their retracted position.

11. The firefighting accessory as claimed in claim 10, wherein at least one or more of the barb members are biased to their deployed position.

12. The firefighting accessory as claimed in claim 4, wherein at least one or more barb members are receivable within channels in the conduit body when the at least one or more barb members are in their retracted position.

13. The firefighting accessory as claimed in claim 1, wherein the closure is configured for closing the aperture in the bulkhead.

14. A method of fighting a fire in a compartment through an aperture in a bulkhead, the method comprising:
a. providing a firefighting accessory as claimed in claim 1;
b. securing the firefighting accessory at or towards the aperture by inserting the fore end of the conduit body at least partly through the aperture, allowing the expanding arrangement to move to its deployed configuration and turning the closure onto the threaded rear end of the conduit body to secure the conduit body in place;
c. connecting a source of extinguishing agent to the firefighting accessory; and
d. directing fire extinguishing agent at the fire via the aperture in the bulkhead.

15. The method of fighting a fire as claimed in claim 14, wherein the step of directing fire extinguishing agent includes the step of:
a. guiding a flow of fire extinguishing agent through a conduit in the conduit body.

16. The method of fighting a fire as claimed in claim 14, wherein the firefighting accessory includes barb members, and the method includes the step of:
a. engaging barb members with the bulkhead on the fire side of the bulkhead to prevent retraction of the firefighting accessory from the aperture.

17. The method of fighting a fire as claimed in claim 14, wherein the step of attaching a source of extinguishing agent to the inlet of the firefighting accessory includes the step of:
a. coupling one or more selected from a firehose and a fire extinguisher to a connector at the rear end of the conduit body.

18. The method of fighting a fire as claimed in claim 14, wherein the method of fighting a fire includes the step of
a. moving the barb members to a retracted configuration before inserting the fore end of the firefighting accessory through the aperture.

19. The method of fighting a fire as claimed in claim 18, wherein the method of fighting a fire includes the step of
a. causing the barb members to move from their retracted configuration to a deployed configuration before engaging the barb members with the bulkhead.
